(19) United States
(12) Patent Application Publication
(10) Pub. No.: US 2002/0171346 A1
(43) Pub. Date: Nov. 21, 2002

(54) Electrodes, method for production thereof and spark plugs with such an electrode

(76) Inventors: Heinz Ulm, Kunreuth (DE); Jochen Fischer, Bamberg (DE)

Correspondence Address: KENYON & KENYON, ONE BROADWAY, NEW YORK, NY, 10004, US

(21) Appl. No.: 10/048,652

(22) PCT Filed: Mar. 30, 2001
(86) PCT No.: PCT/DE01/01268

(30) Foreign Application Priority Data
Jun. 3, 2000 (DE) 10027651.2

(51) Int. Cl. H01T 13/39; H01T 21/02

(52) U.S. Cl. 313/141; 445/7

(57) ABSTRACT

Electrode and spark plug (5) for an internal combustion engine, having an electrode of this type as a center electrode. The electrode includes an electrode base element (20) made of a first material and an end section (30) that is integrally joined to the electrode base element (20), with this end section having a first area (23) that is integrally joined to the first material and is made of a platinum-containing material and having a second area (26) that is integrally joined to the first area (23) and is made of an iridium-containing and/or ruthenium-containing material. A method for manufacturing an electrode of this type, in which a first recess (21) is stamped in the electrode base element (20); a first preform (22) is inserted into the first recess (21); the first preform (22) is melted, thereby forming a first alloy; a second recess (24) is stamped in an area of the first alloy; a second preform (25) is inserted into the second recess (24); and the second preform (25) is melted, thereby forming a second alloy.

The present invention relates to an electrode, a spark plug for an internal combustion engine having an electrode of this type as the center electrode, and a method for manufacturing an electrode of this type, according to the definition of the species in the independent claims.

### BACKGROUND INFORMATION

The service life requirements of spark plugs for internal combustion engines are increasing steadily, since manufacturers often strive for replacement intervals of 60,000 km to 100,000 km in motor vehicles. Such replacement intervals can be achieved, at least in the case of the conventional triple-electrode spark plugs, only by using noble-metal alloys such as platinum alloys or iridium alloys in the electrode area, in particular the center electrode, and applying or attaching these alloys to the electrodes, i.e., nickel-alloy electrode materials, commonly used today by extrusion, plating, resistance welding, laser welding or laser alloying. However, these methods of joining the noble metal alloy to the nickel alloy require highly sophisticated process engineering techniques, since the properties of platinum, and especially iridium, alloys differ enormously from those of nickel alloys in terms of their melting and boiling points as well as thermal expansion coefficients. In addition, preforms, such as pins made, in particular, of iridium alloys, are very expensive to manufacture, due to their low ductility.

A spark plug for an internal combustion engine, which has a center electrode made of an electrode base element and a noble metal tip that is attached to the end face of the electrode base element facing the combustion chamber, is already known from European Patent 785 604 B1. The end section of the electrode base element on the combustion chamber end is also in the shape of a frustum. The noble metal tip according to European Patent 785 604 B1 is further applied to the electrode base element by laser welding or resistance welding and is made of a platinum alloy or an iridium alloy, while the electrode base element is made of a nickel alloy with a core made of a heat-conductive material.

The design of the noble metal tip in the shape of a frustum is also proposed in German Patent Application 100 11 705.8. This publication further proposes the use of a metal alloy, with ruthenium as the primary component, as a spark erosion-resistant electrode material for spark plugs.

Finally, an electrode material in the form of a metal alloy that is particularly suitable for use in spark plugs is proposed in European Patent Application 866 503 A1. This material is a metal alloy with iridium as the primary component and additional noble metals, such as rhodium, ruthenium or rhenium, as secondary components.

It is thus generally known that iridium alloys and ruthenium alloys are suitable for use as electrode materials in spark plugs, due to their extremely high melting points and associated erosion resistance. A process is also known whereby preferably rhodium is added by alloying to iridium, due to the latter's poor oxidation stability. However, alloys of this type are very brittle and thus very expensive to work, which means that the manufacture of preforms, such as pins or disks, which are subsequently to be joined—particularly by welding—to known electrode base elements made, for example, of nickel, is very costly.

### ADVANTAGES OF THE INVENTION

The electrode according to the present invention and the method according to the present invention for manufacturing an electrode of this type have the advantage over the related art that they enable very long-lived spark plugs to be manufactured with simple engineering process techniques, with the spark plug having a noble metal alloy at least in the region of the spark gap of the spark plug.

With the method according to the present invention, it is further advantageous to use spheres made of a material containing platinum or iridium and/or ruthenium as the preforms, for it is possible for these spheres to be manufactured relatively economically from these materials, i.e., alloys, as opposed to pins or disks.

In addition, less ruthenium and, in particular, iridium or an iridium-rhodium alloy need to be used as the material, compared to known electrodes with noble metal alloys of this type, since only the second area is made of an iridium-containing or ruthenium-containing material, while the first area, which is integrally joined to this second area, and which, in turn, is connected to the electrode base element, is made of a platinum-containing material. In particular, platinum is currently less expensive than iridium or rhodium.

The electrode according to the present invention and the method according to the present invention for manufacturing an electrode of this type have the further advantage that, by melting the first preform, thereby forming a first alloy, and by melting the second preform, thereby forming a second alloy, blends or the formation of blended alloy zones are produced by the melting steps at least in the boundary areas between the volume occupied by the first preform and the electrode base element, or between the volume occupied by the second preform and the volume occupied by the first preform, with these alloy zones producing a continuous transition in composition between adjacent materials.

Because, on the one hand, the thermal expansion coefficients of iridium and nickel vary enormously, direct connections between these materials tend to crack apart with the temperature changes that frequently occur in internal combustion engines. Because the thermal expansion coefficient of platinum, on the other hand, lies between those of iridium and nickel, the two melting steps in the method according to the present invention advantageously produce a continuous transition between thermal expansion coefficients even in the transitional zones, i.e., the blended alloy zones, so that the connections created are highly stable, particularly in these blended alloy zones, and do not tend to crack apart.

Another advantage of the electrode according to the present invention and the method according to the present invention is the ability to bypass the boiling point of nickel, which is close to the melting point of iridium. Currently, direct laser welding or laser alloying of iridium and nickel may cause the nickel to evaporate, since the high melting point of iridium makes it necessary to generate a high temperature to achieve metallurgical fusing between these two materials. However, because the electrode base element in the electrode according to the present invention is first integrally joined to a first area made of a platinum-containing material, and this first area is then integrally joined to a second area made of an iridium-containing and/or ruthenium-containing material, and the melting point of platinum lies between those of iridium and nickel, this problem no longer occurs with the electrode according to the present invention and the method according to the present invention, respectively. In particular, the melting point of the platinum-containing material in the first area lies between the melting point of the first material of the electrode base element and the iridium-containing or ruthenium-containing material of the second area.

Another final advantage is that, while iridium alloys are known to be difficult to work, platinum alloys do not have this disadvantage. In the case of the electrode according to the present invention, therefore, both the electrode base element and the end section integrally joined thereto including the first area and the second area, may be shaped, particularly by cutting, without any process engineering difficulties, with it being possible to variably and, and the same time, accurately machine, in particular, the end sections of the electrode. The latter is thus easily manufacturable in more or less any shape and preferably in the shape of a frustum. A shape of this type for the end section is especially advantageous with regard to the service life, flammability and heat dissipation of the electrode according to the present invention and the spark plug manufactured therewith, respectively.

Advantageous embodiments of the present invention are derived from the features described in the subordinate claims.

It is particularly advantageous for the electrode base element to be made of a nickel alloy, at least in one region of the end section, the first area to be made of an alloy of nickel and platinum, and the second area to be made of an alloy of nickel, platinum and iridium. It is further advantageous for the electrode base element itself to have a tapered tip, in particular, in the shape of a cone or frustum, with the end section being attached to its end face so that the end face is integrally joined to the first area of the end section.

According to the method for manufacturing an electrode, it is especially when the first recess and/or the second recess is a dome-shaped recess that may be produced, for example, by stamping with a sphere or hemisphere.

In addition, the preform that is preferably inserted into this first recess or this second recess is a sphere whose volume is selected so that the volume of the sphere is approximately identical to the volume of the first recess and the second recess, respectively.

A laser beam directed frontally onto the end face of the electrode base element, which is used in a manner that is known per se, is especially suitable for melting the first preform inserted into the first recess and the second preform inserted into the second recess, respectively. This laser beam is used in a laser alloying process, i.e., melting the first preform in the first recess with the laser beam produces a first alloy from the material of the first preform and the material of the electrode base element, and melting the second preform in the second recess with the laser beam produces a second alloy from the first alloy and the material of the second preform.

### DRAWING

The present invention is explained in greater detail on the basis of the drawing and in the following description.

FIGS. 1a through 1h show the different method steps in the manufacture of an electrode in the form of a center electrode for a spark plug;

FIG. 2 shows a cross-sectional representation of an extract of a spark plug having a center electrode of this type in the spark gap area.

### DETAILED DESCRIPTION OF THE EMBODIMENTS

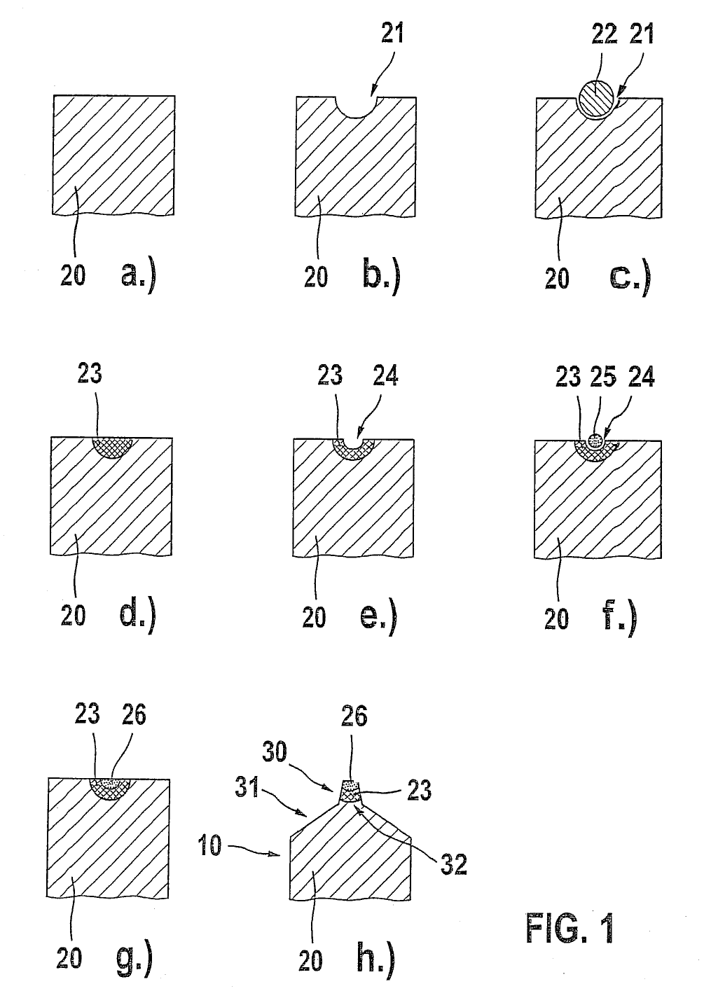

FIG. 1a first shows a known electrode base element 20 made of a nickel alloy, like that frequently used as the material for the center electrode in spark plugs. In particular, electrode base element 20 according to FIG. 1a is designed, in a manner that is known per se, in the shape of a pin with a cylindrical cross section at least in the area that, in a spark plug subsequently manufactured therewith, is located in the spark gap region. FIG. 1b illustrates the next method step in which a dome-shaped first recess 21 is created in an end face of electrode base element 20, using a suitable stamping die. This dome-shaped first recess 21 is, for example, approximately 1 mm deep and has a circular cross-section with a diameter of approximately 1.5 mm when viewed from above.

FIG. 1c then shows how a sphere as first preform 22, which is made of a platinum alloy, is inserted into this created first recess 21. Following the insertion of this first preform 22, a laser beam is directed frontally onto the end face of electrode base element 20 so that first preform 22, including an edge region of first recess 21, is melted, thus forming a first area 23 that is made of a first alloy and contains both platinum and nickel. It should be emphasized at this point that the volume of first preform 22 is a least approximately the same as the volume occupied by first recess 21. During melting of first preform 22, the material of electrode base element 20 is also blended with the platinum alloy of which first preform 22 is made in the region of the boundary surface between first area 23 and electrode base element 20, so that a blended alloy zone forms in this region.

The laser beam used thus generally forms an alloy, by laser alloying, from the material of electrode base element 20 and the platinum alloy of first preform 22, at least in the area of the blended alloy zone.

In addition, this laser alloying process is preferably carried out, and the platinum alloy of which first preform 22 is made is preferably selected, so that a first alloy containing the platinum and nickel in a ratio of 70 to 30 exists in first area 23 following laser alloying.

FIG. 1e illustrates the step that follows FIG. 1d, in which a second dome-shaped recess 24 is now produced, preferably in the center of the area of the end face of electrode base element 20 that is occupied by first area 23. Like first recess 21, this second recess 24 is produced by stamping with a suitable stamping die. Second recess 24 is, for example, approximately 0.5 mm deep and has a diameter of, for example, approximately 0.8 mm, viewing the end face of electrode base element 20 from above.

According to FIG. 1f, a second preform 25 in the shape of a sphere made of an iridium alloy is then inserted into this second recess 24. A laser beam is again directed frontally onto the end face of electrode base element 20 so that inserted second preform 25 and an edge area of second recess 24 melt and form a second area 26. In this case as well, the volume of second preform 25 is selected so that it is preferably at least approximately the same as the volume of second recess 24, with second recess 24 thus being at least almost completely filled by molten second preform 25 after melting. Once again, when melting second preform 25 with the laser used, a material blend, i.e., a laser alloy, is again produced at least in the boundary area between first area 23 and second preform 25 so that a blended alloy zone once again forms at least in this region. This ensures that the first alloy present in first area 23 is blended, i.e., alloyed, with the iridium alloy of second preform 25, at least in the edge area of recess 24 so that, after melting second preform 25, the volume previously occupied by second recess 24 is made, at least in certain areas, of an alloy that contains both platinum and iridium.

In addition to platinum and iridium, second area 26 formed now frequently also contains an alloyed nickel that originated from the first material of electrode base element 20.

Second preform 25 is preferably melted, i.e., the associated laser alloying process is carried out, so that an alloy of the iridium alloy of which second preform 25 was made, and the platinum-nickel alloy of which first area 23 was made, is formed in second area 26. This alloy, which contains both iridium and platinum as well as nickel, preferably has a ratio of 80 to 20 between the iridium and the platinum-nickel alloy from first area 23.

Now that, according to FIG. 1g, both first area 23 and second area 26 have been produced in electrode base element 20, with second area 26 being entirely contained within first area 23, electrode base element 20, first area 23 and second area 26 are subsequently shaped by cutting.

This cutting method of shaping first produces, as shown in FIG. 1h, a tapered, frustum-shaped tip 31 of electrode base element 20, which then merges with an end section 30 formed by first area 23 and second area 26. Furthermore, this end section 30 is preferably also designed at least in the approximate shape of a frustum and integrally joined to electrode base element 20, in particular tip 31, in the area of an end face 32.

In this manner, electrode base element 20 is first integrally joined, in the area of end face 32, to first area 23, which, in turn, is integrally joined to second area 26.

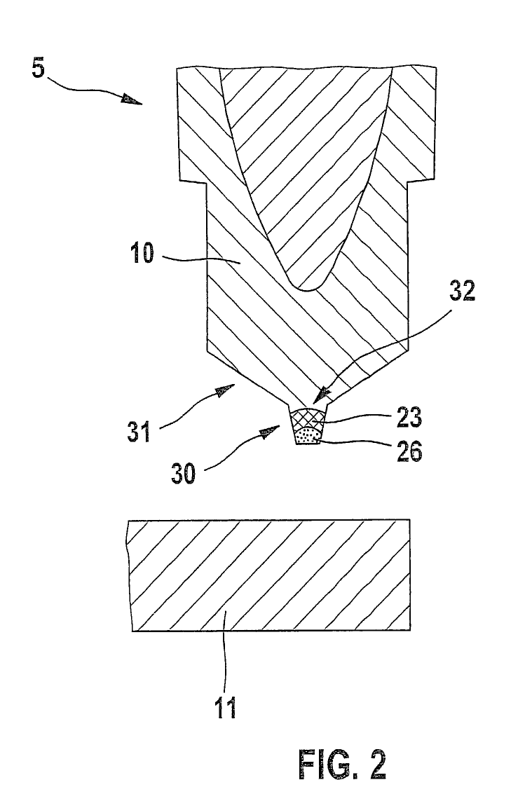

FIG. 2 shows the use of a center electrode 10, prepared according to FIG. 1h, in a spark plug 5. Center electrode 10 is integrated into spark plug 5 in such a manner that second area 26 is opposite a ground electrode 11 and is separated from the latter by a spark gap in a manner that is known per se. Second area 26 according to FIG. 2 is now also integrally joined to first area 23, while first area 23 is integrally joined to tip 31 of electrode base element 20 of center electrode 10.

There is no need at this point to explain the further details of spark plug 5, which are known per se.

According to FIG. 2, therefore, a spark plug 5 with a pointed center electrode 10 is thus produced, having a frustum-shaped end made from end section 30. In second area 26, this end section 30 is made of an iridium alloy to which a platinum-nickel alloy is added by alloying. First area 23, which is made of a platinum-nickel alloy, is thus located between second area 26 and electrode base element 20. Finally, electrode base element 20 itself is made of a nickel alloy.

What is claimed is:

1. An electrode, in particular a center electrode in a spark plug, having an electrode base element (20) made of a first material and an end section (30) that is integrally joined to the electrode base element (20), wherein the end section (30) has a first area (23) that is integrally joined to the first material and is made of a platinum-containing material, and a second area (26) that is integrally joined to the first area (23) and is made of an iridium-containing and/or ruthenium-containing material that is different from the platinum-containing material.

2. The electrode according to claim 1, wherein the first material is nickel or a nickel alloy.

3. The electrode according to claim 1, wherein the platinum-containing material is an alloy of the first material and platinum or a platinum alloy.

4. The electrode according to claim 1, wherein the iridium-containing material is an alloy containing iridium, platinum and the first material; and/or the ruthenium-containing material is an alloy containing ruthenium, platinum and the first material.

5. The electrode according to at least one of the preceding claims, wherein the first material is nickel or a nickel alloy; the first area (23) is made of an alloy of nickel and platinum or an alloy of nickel and a platinum alloy; and the second area (26) is made of an alloy of nickel, platinum and iridium or an alloy of nickel, platinum and ruthenium.

6. The electrode according to claim 1, wherein the electrode base element (20) has a tip (31) that tapers, in particular, in the shape of a cone or frustum, with an end face (32) that is integrally joined to the first area (23) of the end section (30).

7. The electrode according to claim 6, wherein the end section (30) at least has the approximate shape of a frustum, cone or cylinder, with the second area (26) being separated from the tip (31) of the electrode base element (20) by the first area (23).

8. A spark plug for an internal combustion engine having an electrode according to at least one of the preceding claims as the center electrode (10).

9. A method for manufacturing an electrode, in particular a center electrode (10) for a spark plug (5), according to at least one of the preceding claims, including the following method steps:
a.) Preparation of an electrode base element (20) from a first material;
b.) Stamping of a first recess (21), in particular a dome-shaped first recess, in an end face of the electrode base element (20);
c.) Insertion of a first preform (22), in particular a first sphere, into the first recess (21);
d.) Melting of the first preform (22) in the first recess (21), thereby forming a first alloy of the material of the first preform (22) and the material of the electrode base element (20);
e.) Stamping of a second recess (24), in particular a dome-shaped second recess, in an area of the end face of the electrode base element (20) which is occupied by the first alloy of the material of the first preform (22) and the material of the electrode base element (20);
f.) Insertion of a second preform (25), in particular a second sphere, into the second recess (24);
g.) Melting of the second preform (25) in the second recess (24), thereby forming a second alloy of the first alloy and the material of the second preform (25).

10. The method according to claim 9, wherein the volume occupied by the first recess (21) is at least approximately the same as the volume of the first inserted preform (22); and/or the volume occupied by the second recess (24) is at least approximately the same as the volume of the second inserted preform (25).

11. The method according to claim 9, wherein the first and/or second preform (22, 25) is melted with a laser beam that is directed onto the end face of the electrode base element (20).

12. The method according to claim 9 or 11, wherein the first alloy and/or the second alloy is produced by laser alloying.

13. The method according to claim 9, wherein the second recess (24) is stamped in such a way that it lies completely within the volume occupied by the first alloy.

14. The method according to at least one of the preceding claims, wherein method step g.) is followed, in particular, by a cutting process to produce a tip (31) of the electrode base element (20) that tapers, in particular, in the shape of a cone or frustum, with this tip having an end face (32) that is integrally joined to a first area (23) made of the first alloy, which, in turn, is integrally joined to a second area (26) made of the second alloy.

15. The method according to claim 14, wherein the machining process is carried out so that the first area (23) and the second area (26) integrally joined thereto together have the at least approximate shape of a frustum, a cone or a cylinder, with the second area (26) being separated from the tip (31) of the electrode base element (20) by the first area (23).
